(19) United States
(12) Patent Application Publication
(10) Pub. No.: US 2014/0000122 A1
(43) Pub. Date: Jan. 2, 2014

(54) APPARATUS FOR DRYING AND CLASSIFICATION OF A MATERIAL

(71) Applicants: Ilpo Tapio Kylmakorpi, Tampere (FI); Hannu Mansikkaviita, Hyvinkaa (FI); Jyri Juhani Talja, Turenki (FI); Juhani Kalevi Vasaramaki, Ylojarvi (FI)

(72) Inventors: Ilpo Tapio Kylmakorpi, Tampere (FI); Hannu Mansikkaviita, Hyvinkaa (FI); Jyri Juhani Talja, Turenki (FI); Juhani Kalevi Vasaramaki, Ylojarvi (FI)

(73) Assignee: Kumera Oy, Riihimaki (FI)

(21) Appl. No.: 14/004,302

(22) PCT Filed: Apr. 11, 2011
(86) PCT No.: PCT/FI2011/050309

§ 371 Date: Sep. 10, 2013

(51) Int. Cl. F26B 25/16

(52) U.S. Cl. CPC F26B 25/16
USPC 34/60; 34/108

(57) ABSTRACT

An apparatus for drying and classification of a material, the apparatus including a drier (1) having a rotatable drying drum (2) that is substantially horizontal or slightly inclined relative to the horizontal direction for drying a moist material being fed through a first end (3) of the drier, and a screen device (4) provided at a second end (5) of the drier to receive dried material passed through the drying drum for classification of the material. The screen device (4) is a multilayer screen including nested screen drums (6, 7, 8, 17) attached to the drying drum (2) to rotate with the drying drum about a common rotating axis (x-x).

### FIELD OF THE INVENTION

The invention relates to an apparatus as defined in the preamble of claim 1.

### BACKGROUND OF THE INVENTION

Known from the prior art is an apparatus for drying and classification of a material, the apparatus including a drier with a rotatable drying drum. The drying drum is substantially horizontal or slightly inclined relative to the horizontal direction for drying a moist material being fed through a first end of the drier. Further, the apparatus includes a screen device provided at a second end of the drier to receive dried material passed through the drying drum for classification of the material into fractions of different sizes. According to the prior art, the screen device coupled to the drier is structurally a screen drum where a single screen drum comprises sequential screen drum sections corresponding to different screen sizes. The problem is that such a structure makes the combination of the drier and the screen device very long, so that it takes up a large floor area.

### OBJECTIVE OF THE INVENTION

The objective of the invention is to remedy the defects referred to above.

In particular, the objective of the invention is to disclose an apparatus that is substantially shorter than before for drying and classification of a material.

A further objective of the invention is to disclose an apparatus where existing driers can be easily provided with a screen device without needing to change the plant layout to a substantive degree.

### SUMMARY OF THE INVENTION

The apparatus according to the invention is characterized by what has been presented in claim 1.

According to the invention, the screen device is a multilayer screen including nested screen drums attached to the drying drum to rotate with the drying drum about a common rotating axis.

The advantage of the invention is that, by virtue of a short structure of the multilayer screen, the apparatus assembly can be made short and compact. As the multilayer screen is directly attached to the drying drum, it can be rotated by the rotating apparatus of the drying drum, so that a separate rotating apparatus is not needed. In addition, the multilayer screen having a short structure does not need a separate support or bearing, since the support and bearing of the drying drum are sufficient.

In one embodiment of the apparatus, the apparatus includes a discharge chamber at a second end of the drier for receiving dried material and exhaust gas from the drying drum and for separating them from each other. The screen device is provided in the interior of the discharge chamber.

In one embodiment of the apparatus, the screen device includes a first screen drum with a first screen size and a second screen drum fitted coaxially to surround the first screen drum, a second screen size of the second screen drum being smaller than the first screen size of the first screen drum in such a way that, as the screen device is operating, the material passing through the first screen drum drops onto the second screen drum.

In one embodiment of the apparatus, the first screen drum includes an end adjacent to the drying drum and a farther end relative to the drying drum. The first screen drum is open at the farther end for allowing a material that is coarser than the first screen size to escape from the first screen drum for the purpose of being conveyed out.

In one embodiment of the apparatus, the screen device includes a third screen drum fitted to surround the second screen drum.

In one embodiment of the apparatus, a third screen size of the third screen drum is substantially equal to the screen size of the second screen drum.

In one embodiment of the apparatus, the screen device includes an oblique partition wall that is impenetrable to the material and that is provided between the inner screen drum and the next outermost screen drum surrounding the inner screen drum to guide the material passed through the inner screen drum toward an opening at the end adjacent to the drying drum.

In one embodiment of the apparatus, the partition wall is provided between the second screen drum and the third screen drum to guide the material passed through the second screen drum toward the opening at the end adjacent to the drying drum and to prevent the material passed through the second screen drum from dropping onto the third screen drum.

In one embodiment of the apparatus, the third screen drum is shaped as a frustum of a cone in such a way that a greater-diameter end of the cone is the end on the side of the drying drum. The direction of movement on the second screen drum of the material not passing through the second screen drum is oriented toward the farther end relative to the drying drum, from where the material drops onto the third screen drum, on which the direction of movement of the material not passing through the third screen drum is oriented toward the end adjacent to the drying drum.

In one embodiment of the apparatus, the end of the third screen drum adjacent to the drying drum has an opening through which the material not passing through the third screen drum can escape from the third screen drum.

In one embodiment of the apparatus, a partition wall is provided between the first screen drum and the second screen drum to guide the material passed through the first screen drum toward the opening at the end adjacent to the drying drum.

In one embodiment of the apparatus, the material moves on each screen drum in the screen device from the end adjacent to the drying drum to the farther end.

In one embodiment of the apparatus, the screen device is divided by sectors into parts separated from each other by partition walls, wherein a channel leads from the opening to each screen drum for alternately guiding the material to the different screen drums.

In one embodiment of the apparatus, the apparatus includes a crusher to which the material not passing through the screen drums is arranged to be guided for crushing the material.

### LIST OF FIGURES

In the following section, the invention will be described in detail by exemplifying embodiments with reference to the accompanying drawing in which

FIG. 1 schematically illustrates a first embodiment of the apparatus according to the invention as a partially cross-sectional view,

FIG. 2 schematically illustrates a multilayer screen device included in a second embodiment of the apparatus according to the invention as seen from the end,

FIG. 3 shows section of FIG. 2,

FIG. 4 shows section IV-IV of FIG. 2, and

FIG. 5 shows section V-V of FIG. 2.

### DETAILED DESCRIPTION OF THE INVENTION

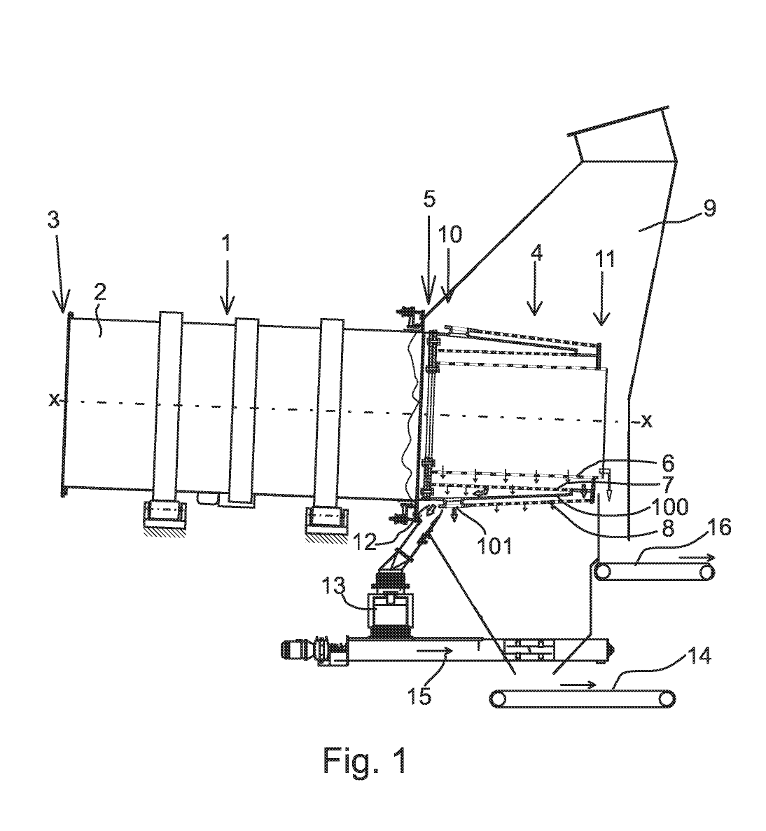

FIG. 1 shows an apparatus for drying and classification of a material, the apparatus including a drier 1 with a rotatable drying drum 2. The drying drum 2 is slightly inclined relative to the horizontal direction. The drying drum 2 dries a moist material as the material moves through the rotating drying drum from a first end 3 to a second end 5. A screen device 4 is provided at the second end 5 of the drier to receive dried material passed through the drying drum 2 for classification of the material into fractions by the screen device 4.

The screen device 4 is a multilayer screen including nested screen drums 6, 7, 8 attached to the drying drum 2 for example by a bolted joint between the end flanges to rotate with the drying drum about a common rotating axis x-x. For ensuring the flow of material, the rotating axis x-x is inclined at a small angle relative to the horizontal direction, typically for example at an angle of approximately 2°.

The apparatus includes a discharge chamber 9 at the second end 5 of the drier for receiving dried material and exhaust gas from the drying drum 2 and for separating them from each other. The screen device 4 is disposed in the interior of the discharge chamber 9.

The screen device 4 includes a first screen drum 6 with a first screen size and a second screen drum 7 coaxially fitted to surround the first screen drum 6. A second screen size of the second screen drum 7 is smaller than the first screen size of the first screen drum in such a way that, as the screen device is operating, the material passing through the first screen drum 6 drops onto the second screen drum 7.

The first screen drum 6 includes an end 10 adjacent to the drying drum 2 and a farther end 11 relative to the drying drum 2. The first screen drum 6 is open at the farther end 11, so that material that is coarser than the first screen size can escape from the first screen drum 6 through the open end for the purpose of being conveyed out.

The screen device 4 also includes a third screen drum 8 fitted to surround the second screen drum 7, a third screen size of the third screen drum being substantially equal to the screen size of the second screen drum. The third screen drum 8 is shaped as a frustum of a cone in such a way that a greater-diameter end the cone is the end 10 on the side of the drying drum. The direction of movement on the second screen drum 7 of the material not passing through the second screen drum 7 is oriented toward the farther end 11 relative to the drying drum. A solid partition wall 100 shaped as a cylinder or a frustum of a cone and impenetrable to the material is provided between the second screen drum 7 and the third screen drum 8 to guide the material passed through the second screen drum 7 toward an opening 101 at the end 10 adjacent to the drying drum, from which the screened fraction may drop onto the base of the discharge chamber 9/conveyor 14 to be conveyed out. The partition wall 100 prevents the material passed through the second screen drum 7 from dropping onto the third screen drum 8. The end 10 of the third screen drum 8 adjacent to the drying drum has an opening 12 through which the material not passed through the third screen drum 8 can escape from the third screen drum 8. The apparatus includes a crusher 13 into which the material not passed through and escaping from the third screen drum 8 through the opening 12 is arranged to be guided for the purpose of being crushed.

Further, the apparatus of FIG. 1 includes a first conveyor 14 arranged to receive the material passed through the second screen drum 7 and the third screen drum 8 and dropping into the bottom part of the discharge chamber 9 for the purpose of being conveyed out, and a second conveyor 15 arranged to convey the crushed material from the crusher 13 to the first conveyor 14.

In addition, the apparatus of FIG. 1 includes a third conveyor 16 arranged to receive the material not passed through the first screen drum 6 for the purpose of being conveyed out from the first screen drum 6.

According to one illustrative exemplifying embodiment in FIG. 1 the screen size of the first screen drum 6 is 15 mm and the screen size of the second screen drum 7 and the third screen drum 8 is 2 mm. As the material enters the first screen drum 6 from the drying drum 2 while the drying drum 2 and consequently the screen device 4 are rotating, the material of which the grain size is greater than 0 and smaller than 15 mm (a fraction of −15 mm) passes through the first screen drum 6 and arrives at the second screen drum 7. The material with a grain size greater than 15 mm, i.e. a fraction of +15 mm, moves to the open end of the first screen drum 6 and drops onto the third conveyor 16 to be taken out. Part of the fraction of −15 mm entering the second screen drum 7, i.e. a fraction of −2 mm, with a grain size smaller than 2 mm, passes through the second screen drum 7 and drops onto the partition wall 100 guiding the fraction of −2 mm to the opening 101 and to the bottom part of the discharge chamber. On the second screen drum 7, the material with a fraction of +2 mm and possibly a quantity of the fraction of −2 mm not having been screened through the screen drum 7 drops through the opening at the farther end 11 of the second screen drum 7 relative to the drying drum to the conical third screen drum 8. The fraction of −2 mm passing through the third screen drum 8 drops into the bottom part of the discharge chamber 9 and the fraction of +2 mm not passing through the third screen drum 8 moves on the third screen drum 8 toward the opening 12 at the end adjacent to the drying drum, guiding the fraction of +2 mm to the crusher 13. The fraction of −2 mm drops into the bottom part of the discharge chamber 9 onto the first conveyor 14 to be taken out. The fraction of +2 mm is crushed by the crusher 13 to a fraction of −2 mm and the crushed material is conveyed by the second conveyor 15 to the first conveyor 14 to be taken out.

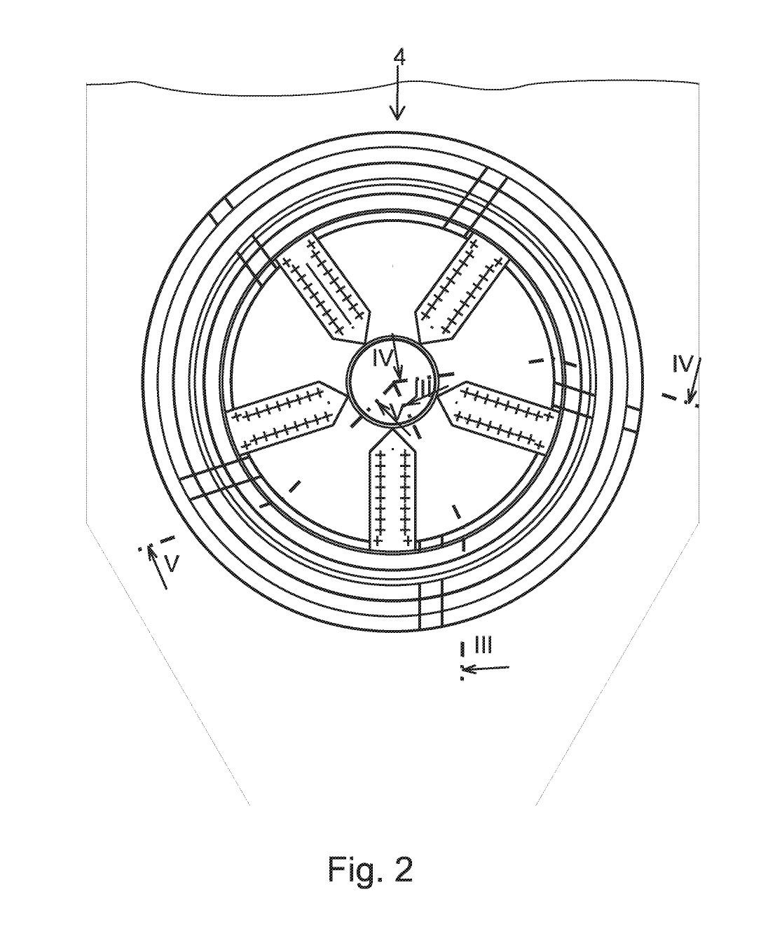

FIG. 2 shows the multilayer screen device 4 divided into sector parts, the structure of which is illustrated by cross-sectional views 3, 4 and 5.

The screen device 4 according to FIGS. 2 to 5 is characterized in that the material moves on each screen drum 6, 7, 8, 17 in the same direction, i.e. from the end 10 adjacent to the drying drum to the farther end 11, and the material passed through the innermost first screen drum 6 of a coarse screen size is divided directly at the end 10 adjacent to the drying drum onto different screen layers 7, 8, 17.

The drying drum 2 according to FIGS. 2 to 5 being rotated in the apparatus is substantially horizontal or slightly inclined relative to the horizontal direction. The screen device 4 is a multilayer screen including nested screen drums 6, 7, 8, 17 attached to the drying drum 2 to rotate with the drying drum about a common rotating axis x-x. The apparatus includes a discharge chamber 9 for receiving dried material and exhaust gas from the drying drum 2 and for separating them from each other. The screen device 4 is provided in the interior of the discharge chamber 9.

The screen device 4 includes a first screen drum 6 of a first screen size. The first screen drum 6 is open at the farther end 11 for allowing a material that is coarser than the first screen size to escape from the first screen drum for the purpose of being conveyed out.

In addition to the first screen drum 6, the screen device 4 includes three other coaxial screen drums, a second screen drum 7 surrounding the first screen drum 6, a third screen drum 8 surrounding the second screen drum 7 and a fourth screen drum 17 surrounding the third screen drum 8.

An oblique partition wall 102 is provided between the first screen drum 6 and the second screen drum 7 to guide the material passed through the first screen drum 6 toward an opening 103 at the end 10 adjacent to the drying drum.

The screen device 4 is divided in sectors (e.g. a division of 60°, 72°, 90°, 120° etc.) by different distribution channels 20, 21, 22, by means of which the material passed through the innermost screen mesh 6 is guided, while the device is rotating, onto the screen drums 7, 8, 17 at different levels. Their undersize, i.e. the material fraction passed through, moves, by means of metal cylinders 18, 19, to undersize discharge channels 23, 24, through which the desired fraction moves to the discharge chamber 9. The material moves on each screen drum 6, 7, 8, 17 in the screen device 4 from the end 10 adjacent to the drying drum 2 to the farther end 11.

The fraction passed through each screen drum 7, 8, 17 is discharged through outer screen layers via respective discharge channels 23, 24 and drops to the bottom part of the discharge chamber 9 to be discharged by a conveyor etc. The fraction not passing through the screen drums 7, 8, 17 escapes from the farther end 11 relative to the drying drum and is guided apart for the purpose of further operations (crushing/transport).

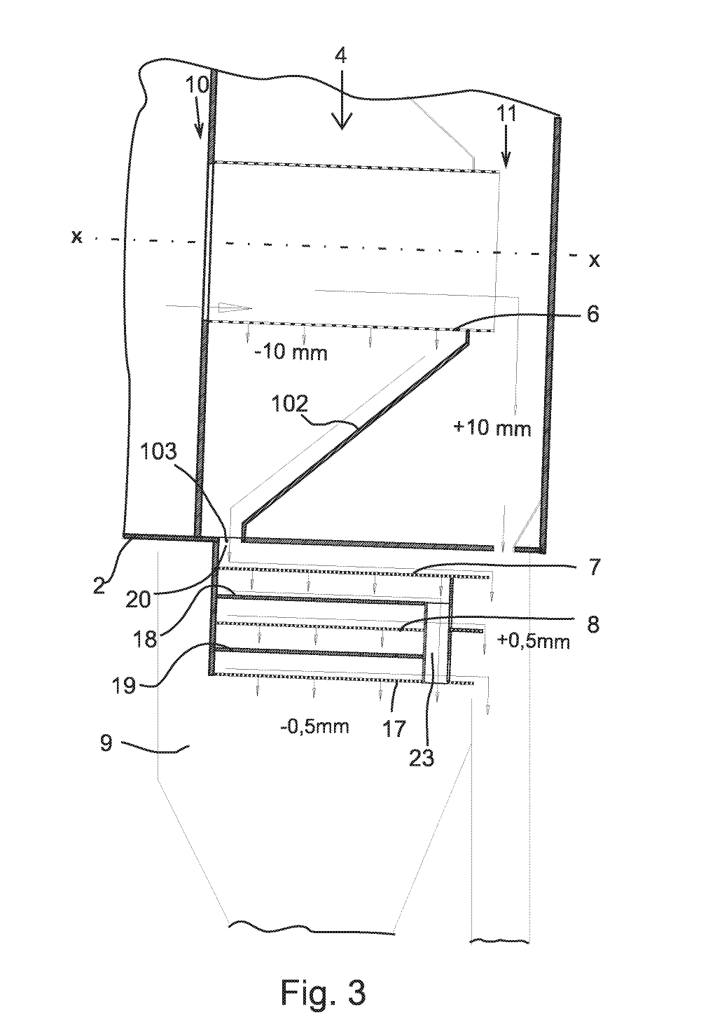

According to one illustrative exemplifying embodiment in FIGS. 2 to 5 the screen size of the first screen drum 6 is 10 mm. The screen size of the second screen drum 7, the third screen drum 8 and the fourth screen drum 17 is 0.5 mm. FIGS. 3 to 5 indicate the movement of different fractions by arrows. The coarse fraction of +10 mm not passing through the first screen drum 6 drops at the farther end 11 relative to the drying drum and is guided to further processing (e.g. crushing).

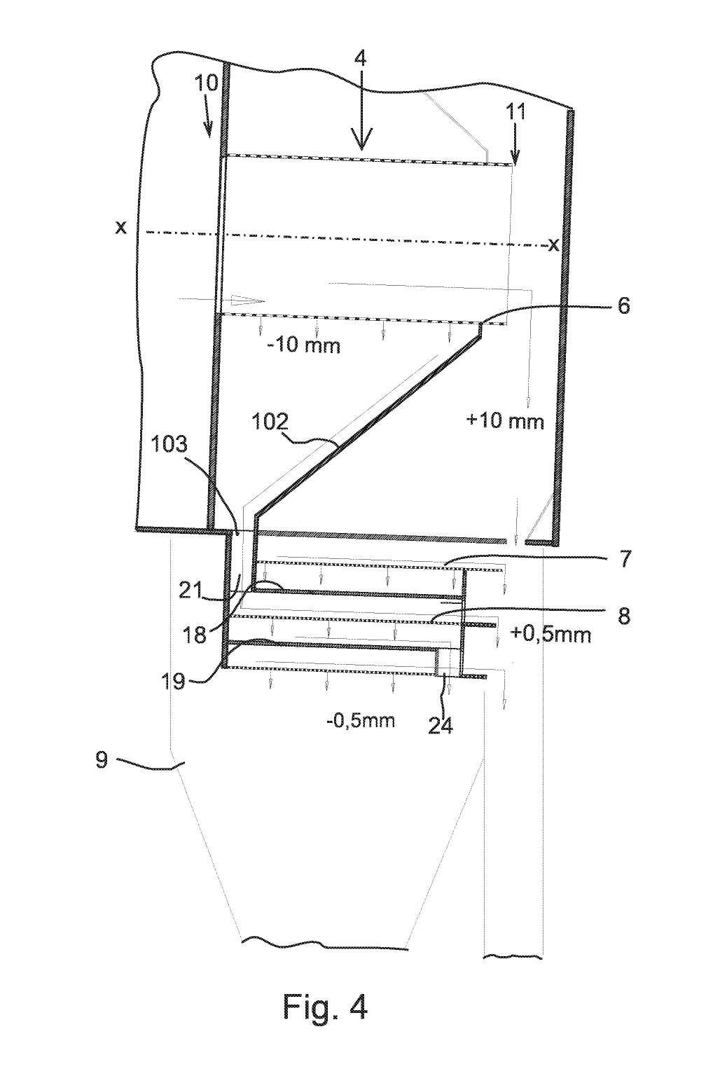

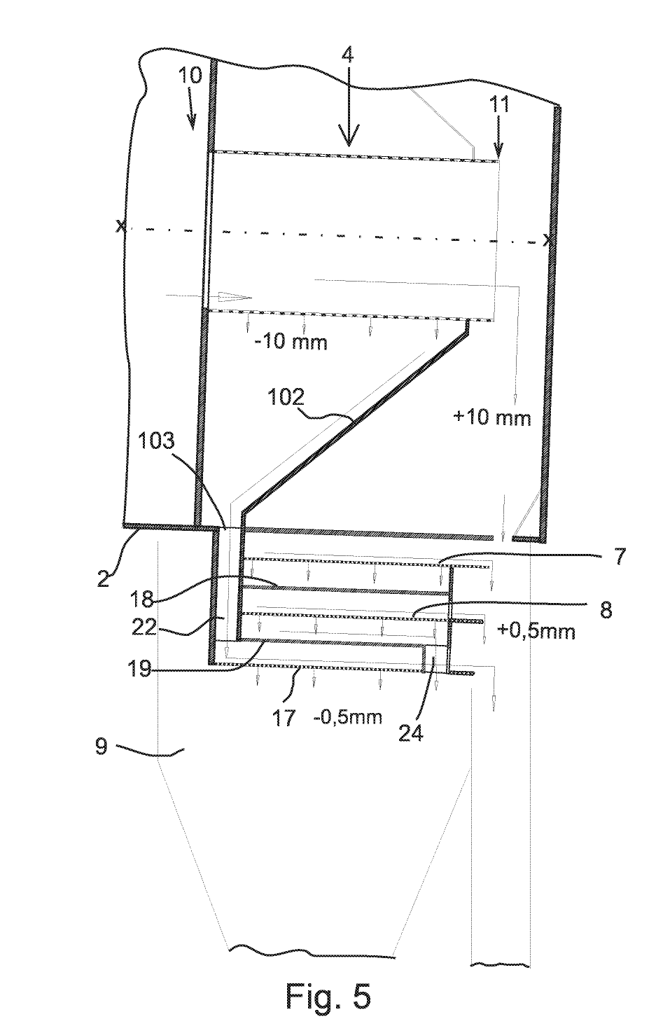

The fraction of −10 mm passed through the first screen drum 6 drops into the opening 103 in the guidance of the oblique partition wall 102. FIG. 3 illustrates a situation where the fraction of −10 mm is guided from the opening 103 into the channel 20 and onto the second screen drum 7. FIG. 4 illustrates a situation where the fraction of −10 mm is guided from the opening 103 into the channel 21 and onto the third screen drum 8. FIG. 5 illustrates a situation where the fraction of −10 mm is guided from the opening 103 into the channel 22 and onto the fourth screen drum 17. The fraction of +0.5 mm not passing through the screen drums 7, 8 and 17 escapes from the farther end 11 relative to the drying drum and is guided apart for the purpose of further operations (crushing/transport). The fraction of −0.5 mm passed through the screen drums 7, 8, 17 escapes in the guidance of cylindrical partition walls (undersize guide plates) 18, 19 and drops into the bottom part of the discharge chamber 9 to be taken for further processing.

The invention is not limited to the number of screen drums or to the screen sizes or to the number of fractions presented in the examples.

The invention is not limited merely to the exemplifying embodiments referred to above; instead, many variations are possible within the scope of the inventive idea defined by the claims.

1. An apparatus for drying and classification of a material, the apparatus including a drier having a rotatable drying drum that is substantially horizontal or slightly inclined relative to the horizontal direction for drying a moist material being fed through a first end of the drier, and a screen device provided at a second end of the drier to receive dried material passed through the drying drum for classification of the material, the screen device being a multilayer screen including nested screen drums attached to the drying drum to rotate with the drying drum about a common rotating axis wherein the screen device includes a partition wall that is impenetrable to the material, provided between a screen drum and a surrounding next outermost screen drum to guide the material passed through the screen drum toward an opening at an end adjacent to the drying drum.

2. The apparatus according to claim 1, wherein the apparatus includes a discharge chamber at the second end of the drier for receiving dried material and exhaust gas from the drying drum and for separating them from each other; and that the screen device is provided in the interior of the discharge chamber.

3. The apparatus according to claim 1, wherein the screen device includes a first screen drum with a first screen size, a second screen drum fitted coaxially to surround the first screen drum, a second screen size of the second screen drum being smaller than the first screen size of the first screen drum in such a way that, while the screen device is operating, the material passing through the first screen drum (6) drops onto the second screen drum.

4. The apparatus according to claim 1, wherein the first screen drum includes an end adjacent to the drying drum and a farther end relative to the drying drum; and that the first screen drum is open at the farther end for allowing material that is coarser than the first screen size to escape from the first screen drum for the purpose of being conveyed out.

5. The apparatus according to claim 4, wherein the screen device includes a third screen drum fitted to surround the second screen drum.

6. The apparatus according to claim 5, wherein a third screen size of the third screen drum is substantially equal to the screen size of the second screen drum.

7. The apparatus according to claim 1, wherein a partition wall is provided between the second screen drum and the third screen drum to guide the material passed through the second screen drum toward an opening at the end adjacent to the drying drum and to prevent the material passed through the second screen drum from dropping onto the third screen drum.

8. The apparatus according to claim 7, wherein the third screen drum is shaped as a frustum of a cone in such a way that a greater-diameter end of the cone is the end on the side of the drying drum; and that the direction of movement on the second screen drum of the material not passing through the second screen drum is oriented toward the farther end relative to the drying drum, from where the material drops onto the third screen drum on which the direction of movement of the material not passing through the third screen drum is oriented toward the end adjacent to the drying drum.

9. The apparatus according to claim 8 wherein partition wall is provided between the first screen drum and the second screen drum to guide the material passed through the first screen drum toward the opening at the end adjacent to the drying drum.

10. The apparatus according to claim 7, wherein the material moves on each screen drum in the screen device from the end adjacent to the screen drum to the farther end.

11. The apparatus according to claim 10, wherein the screen device is divided by cylindrical partition walls as sectors into separate parts where a channel leads from the opening to each screen drum for alternately guiding the material onto different screen drums.

12. The apparatus according to claim 1, wherein the apparatus includes a crusher to which the material not passing through the screen drums is arranged to be guided for crushing the material.
